(19) United States
(12) Patent Application Publication
(10) Pub. No.: US 2006/0186062 A1
(43) Pub. Date: Aug. 24, 2006

(54) Filter support member and methods of use and fabrication

(75) Inventors: Julian R. Pauwels, Thomasville, GA (US); Dwight W. Smith, Thomasville, GA (US); Jimmy L. Speigner, Thomasville, GA (US); Tommy E. Glass, Pavo, GA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: USFilter Corporation, Warrendale, PA (US)

(21) Appl. No.: 11/063,235

(22) Filed: Feb. 22, 2005

(51) Int. Cl. B01D 24/00

(52) U.S. Cl. 210/807; 210/271; 210/291

(57) ABSTRACT

A filter apparatus has filter media support member resistant to bacterial activity. The filter media support member can have one or more channels configured to retain filter media while permitting fluid flow therethrough in a non-tortuous fluid flow path through channels. The channels typically have smooth, asperities-free channel walls.

### BACKGROUND OF INVENTION

1. Field of Invention

The invention relates to filter apparatus and, in particular, to filter media support members typically utilized in traveling bridge filter media systems.

2. Discussion of Related Art

Filter systems and methods have been disclosed. For example, Ross, in U.S. Pat. No. 4,627,923, discloses an apparatus and method of filtering solids from a liquid effluent. Johnson et al., in U.S. Pat. No. 4,540,487, disclose a filter apparatus. Pauwels, in U.S. Pat. No. 4,859,330, discloses a traveling bridge filter with air scour. Pauwels, in U.S. Pat. No. 4,957,631, further discloses a traveling bridge filter with surface wash. Medders, in U.S. Pat. No. 4,988,439, discloses a two stage traveling bridge filter. Wang et al., in U.S. Pat. No. 5,256,299, disclose a method and apparatus for liquid treatment. McDougald, in U.S. Pat. No. 5,554,281, discloses a traveling bridge filter system and an associate underdrain.

Components and/or subsystems of filter systems have also been disclosed. For example, Ferri, in U.S. Pat. Nos. 4,882,053 and 5,202,022, discloses porous filter media support plates. Hambley, in U.S. Pat. No. 5,019,259, discloses a filter underdrain apparatus with partitioned distributor conduits. Brown et al., in U.S. Pat. No. 5,149,427, disclose a cap for underdrains in gravity filters. McDougald, in U.S. Pat. No. 5,792,359, discloses cell-less traveling bridge filters. Shea et al., in U.S. Pat. No. 5,865,999, disclose a nozzle-less underdrain for granular filtration systems. Medworth, in U.S. Pat. No. 5,976,370, discloses an underdrain structure for media filters. McDougald, in U.S. Pat. No. 6,093,329, discloses an air scour/backwash apparatus for cell-less traveling bridge filters. Hambley et al., in U.S. Pat. No. 6,797,166, disclose an underdrain apparatus.

### SUMMARY OF INVENTION

In accordance with one or more embodiments, the invention is directed to a filter media support plate having a filter media-facing surface and a drain-facing surface. The support plate can comprise a plurality of passages having a substantially smooth passage wall and sized to retain filter media while permitting flow of a fluid from the media-facing surface to the drain-facing surface. The flow path can be tortuous-free between the filter media-facing surface and the drain-facing surface.

In accordance with one or more embodiments, the invention is directed to a traveling bridge filter apparatus including filter media comprising an inlet and a drain. The apparatus can comprise a support plate disposed to support the filter media. The support plate can comprise a media-facing surface and a drain-facing surface and at least one channel defining a flow path from the media-facing surface to the drain-facing surface. The at least one channel can be sized to provide a fluid flow path with an effective pressure drop of less than about 70 kilopascals (about 10 psi) between the media-facing surface and the drain-facing surface.

In accordance with one or more embodiments, the invention provides a method of fabricating a media support member comprising an act of laser cutting at least one channel through a plate, the at least one channel sized to prevent entry of filter media while permitting a fluid to pass through the at least one channel.

In accordance with one or more embodiments, the invention provides a method of treating water in a filter apparatus having at least one filter cell defined at least by filter cell walls and a filter cell media support plate. The filter media support plate can have a media-facing surface and a drain-facing surface. The method can comprise acts of introducing water into the at least one filter cell; promoting water passage through the filter media; and draining water through the filter cell media support plate in a tortuous-free flow path from the media-facing surface to the drain-facing surface.

### BRIEF DESCRIPTION OF DRAWINGS

The accompanying drawings are not intended to be drawn to scale. In the drawings, each identical or nearly identical component that is illustrated is represented by a like numeral. For purposes of clarity, not every component may be labeled in every drawing. In the drawings:

FIG. 1 is a schematic side view of a filter system in accordance with one or more embodiments of the invention;

FIG. 2 is a schematic perspective view of a portion of the filter system depicted in FIG. 1 in accordance with one or more embodiments of the invention;

FIG. 3 is a top view of a media support member in accordance with one or more embodiments of the invention; and

FIG. 4 is a copy of a photograph of a support plate in accordance with one or more embodiments of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In accordance with one or more embodiments, the filter apparatus of the invention can utilize a filter media support member that can be resistant to bacterial activity. The filter media support member can have one or more channels configured to retain filter media while permitting fluid flow therethrough in a non-tortuous fluid flow path through channels having smooth, asperities-free channel walls.

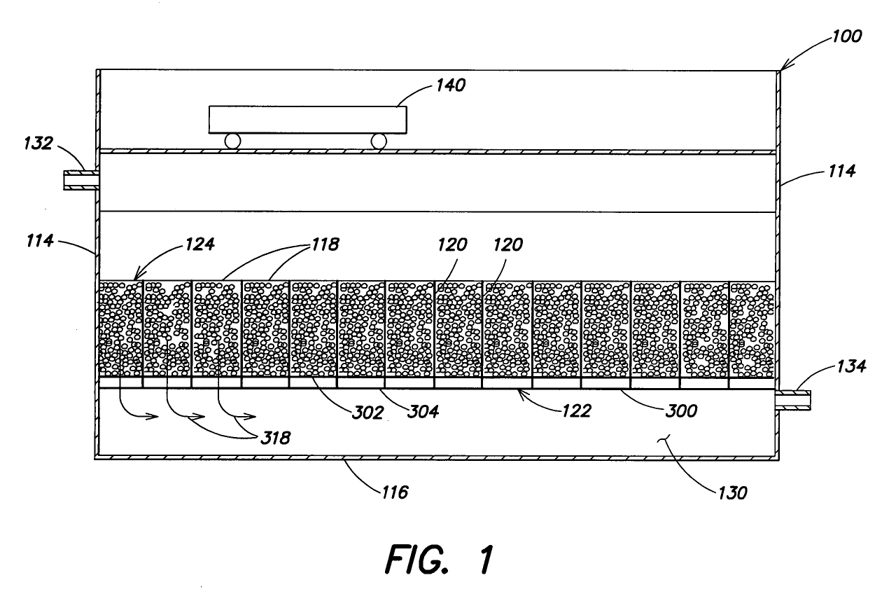

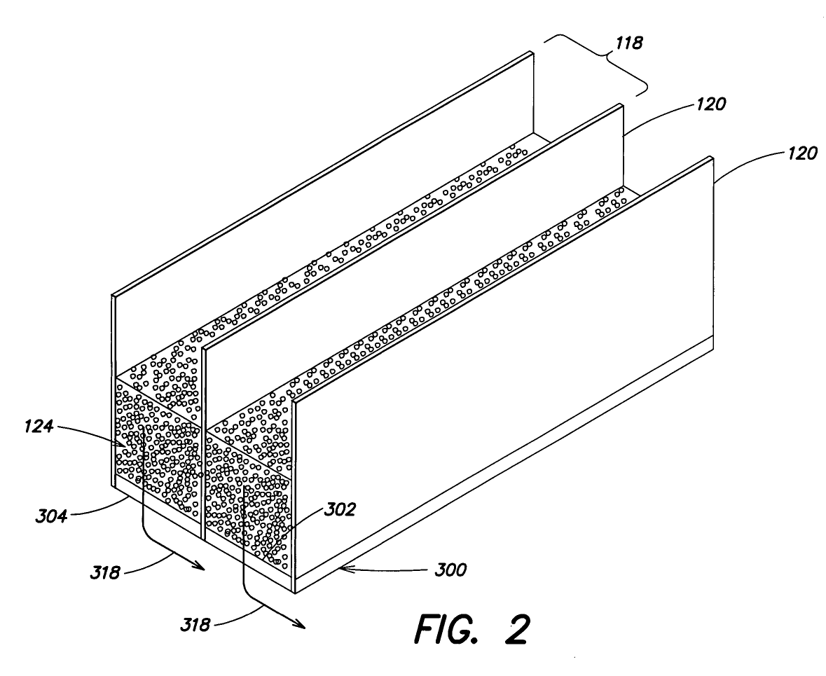

Referring to FIGS. 1-3, a filter apparatus, and components or sections thereof, in accordance with one or more embodiments of the invention are exemplarily shown. The filter apparatus can comprise a tank 100, typically rectangularly-shaped, including side walls, end walls 114, and bottom wall 116. Tank 100 can comprise one or a plurality of filter cells 118 exemplarily shown as being defined by upright, spaced-apart partitions or walls 120, which typically extend across a dimension, e.g. width, of tank 100, in, for example, a parallel arrangement and typically transversely of the direction of elongation of the tank. The shape of the tank and the orientation of the one or more filter cell subsections may be varied in accordance with particular requirements of the filtering system in which the filter apparatus is utilized. For example, the filter apparatus can comprise an elongated, rectangular filtration tank divided into one or more cells by a plurality of laterally spaced partitions, typically in a substantially parallel configuration. As noted, such partitions can extend across the width of the tank.

Cell 118 can further comprise and also be defined by an underdrain or subfloor 122. Underdrain 122 can comprise and/or be defined, at least, by support member 300 typically resting on, supported by, and/or supporting partitions 120. In accordance with some embodiments of the invention, one or more filter media beds 124 comprising suitable filter material is typically contained in filter cell 118 and can be further contained and/or supported by filter media support member 300. A volume between wall 116 and subfloor 122 can define a clearwell or chamber 130. Support member 300 can have at least one filter media-facing surface 302 and at least one drain-facing surface 304. Media-facing surface 302 is typically in contact with, contiguous, and/or adjacent to the filter media material in filter media bed 124. Drain-facing surface 304 is typically fluidly communicable with one or more drains or outlets, typically through chamber 130.

The filter media in filter media bed 124 can comprise, in accordance with one or more embodiments of the invention, a multi-layer arrangement of granular material. Examples of filter media material that can be utilized in accordance with various embodiments of the invention include, but are not limited to, one or more layers of any of gravel, sand, and/or anthracite and/or other suitable material that can effect filtration by, for example, retaining or entrapping particulate material or other undesirable species to be removed from the fluid to be treated.

The filter apparatus can further comprise one or more inlets 132 through which the fluid to be treated can enter into and be contained in tank 100. For discussion purposes, water will be used herein as the fluid to be treated. Under typical conditions, water is supplied to the tank at a level above the filter media bed 124. The filter apparatus can further comprise one or more outlets 134, typically fluidly connected to chamber 130, through which treated water, i.e. clarified water, can exit the filter apparatus.

During typical filtering operating conditions, water having particulate material or other undesirable species to be removed therefrom can enter the filter apparatus through one or more inlets 132 and flow into one or more cells 118, wherein filter media in filter media bed 124 can entrap, retain, facilitate retention, and/or at least hinder movement with the water of the one or more undesirable species. Thus, during filtering operation, particulate matter can be entrapped within the granular filter media material.

Water thus having at least a portion of one or more undesirable material removed therefrom can then exit the filter apparatus through one or more outlets 134. In particular, water can flow through the filter media in filter media bed 124 from a media-facing surface 302 to a drain-facing surface 304 of support member 300 into chamber 130 in a flow path represented by reference 318. Clarified water, having the undesirable material removed therefrom, can then be withdrawn from chamber 130, exemplarily shown as being disposed beneath the one or plurality of filter cells 118, through outlet 134.

The particulate matter can saturate the filter media, thereby reducing filtering effect. Thus, periodic cleaning of the one or more filter cells 118 may be advantageous, which is further discussed below.

Support member 300 typically comprises one or more channels, apertures, or passages 310 that permit and/or define a fluid path between media-facing surface 302 and drain-facing surface 304. In some cases, fluid, typically treated or clarified water exiting filter media bed 124, enters the one or more channels 310 and flows in a tortuous-free flow path between media-facing surface 302 to drain-facing surface 304 into chamber 130.

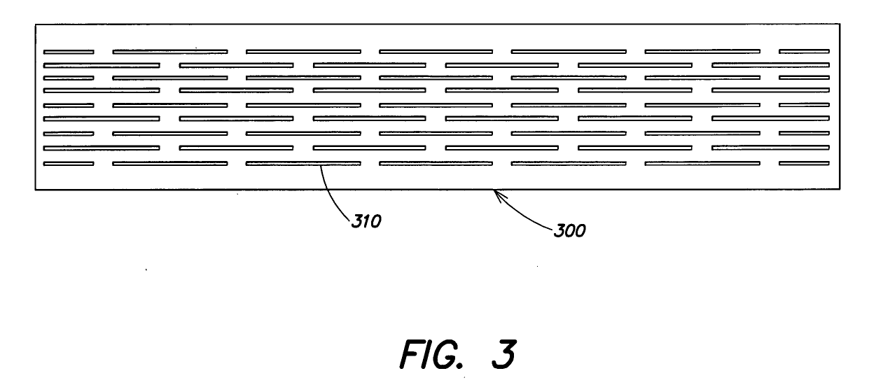

As exemplarily shown in FIG. 3, support member 300 can comprise a plate, such as a rectangular plate having a plurality of channels 310. The one or more channels 310 can provide or define one or more fluid flow paths that permit fluid flow while retaining or preventing filter media material to exit filter cell 118. In accordance with some aspects of the invention, the entrance of the one or more channels can be sized to be smaller than the filter media material. Thus, channel 310 can be configured and/or sized to have a smallest dimension that is smaller than an average smallest dimension of the filter media material and/or an average or nominal diameter of the filter media material. As used herein, the phrase average smallest dimension is an averaged dimension of the filter media material in its smallest aspect.

As exemplarily shown in FIG. 3, channel 310 is represented by a cut or aperture through the thickness of the rectangular plate comprising support member 300. Thus, in some embodiments of the invention, the smallest dimension with respect to channel 310 can be a width thereof across rather than a lengthwise dimension. Notably, the one or more channels 310 can have any suitable shape that accommodates fluid flow from a first end, surface, or inlet side to a second end, surface, or outlet side in, in some cases, a tortuous-free manner. For example, although the channels at the media-facing surface can have circular, cross-shaped, or even oval-shaped openings or entrances, preferably such that the channels defined through the plate provide substantially straight fluid flow lines or paths. Moreover, a plurality of geometrical configurations of channels can be utilized. For example, support member 300 can have slit-shaped channels as well as cross-shaped channels. In some cases, support member 300 can have varied channel densities. For example, support member 300 can have a lower channel density, less channels per unit surface area, around the support member edges relative to its center. This provides flexibility with respect to tailoring flow behavior through the filter media bed. Further, the channel density can be varied along the support member to increase structural strength. For example, support member 300 can have regions including high channel density separated by regions with no channels or low channel density so as to effectively provide structural support an allowing use of relatively thinner support members.

Support member 300 need not be limited to the rectangular shape depicted in FIG. 3 but be constructed and arranged to have any suitable character. For example, support member 300 can be constructed as a circular plate. Moreover, in accordance with one or more embodiments of the invention, support plate 300 can define at least a portion of chamber 130 serving as a manifold to collectively collect clarified water from the one or more filter cells 118. Thus, chamber 130 can assume any geometrical configuration including at least one wall having defined therein one or more channels fluidly connecting the filter cell 118 to the drain such that the one or more channels define at least one fluid flow path that is, preferably, tortuous-free.

Further, in accordance with one or more embodiments of the invention, the one or more channels 310 can have substantially smooth walls or surfaces that are typically free of asperities or other surface features that can resist or at least does not promote attachment thereon and/or growth of microorganisms or biological activity. The tortuous-free flow paths in the one or more channels can be described as defining straight flow lines that avoids abrupt changes in direction path. In some cases, the tortuous-free flow path can be free of eddies and/or define non-turbulent, laminar flow profiles, at least, for example, from the media-facing surface to the drain-facing surface.

The support member of the invention can be fabricated in any suitable manner that provides an asperities-free, substantially smooth surface channel wall, and/or define tortuous-free flow path from a first face or surface to a second face or surface thereof. The channels can also be free of any pockets that can accumulate nutrients upon which bacterial activity can develop. For example, a support plate in accordance with one or more embodiments of the invention can be fabricated by utilizing one or more laser systems to cut the one or more channels creating an asperities-free, substantially smooth surface channel wall and, in some cases, define a tortuous-free flow path. Further, wetted surfaces of the support plate can also have a coating that renders the channel wall or surfaces free of asperities or pockets.

In accordance with one or more embodiments of the invention, the support member can comprise a plate having one or more channels that are constructed and arranged to permit fluid flow at a predetermined rate or with an allowable or desired pressure loss or drop. For example, support member 300 can have channels sized to have a smallest, for example, cross-wise, dimension of about 0.015 inch and arranged to provide a channel spacing of about 0.75 inch. Such an exemplary configuration can, depending on operating conditions, provide a pressure drop, across the support plate, of about 70 kilopascals (about 10 psi) or less.

The support member can have any suitable thickness that provides a desired resistance to loading deformation during service or operation of the filter apparatus. Thus, for example, the support plate can be comprised of steel having a thickness of about 0.1875 inch. For example, the plate can comprise stainless steel such as, but not limited to 316 grade stainless steel. However, the thickness of the support member need not be limited as such and the material of construction of the support plate also need not be limited to steel or stainless but can be any material having a suitable modulus and/or tensile strength that is structurally stable during service.

Filtering systems in accordance with one or more embodiments of the present invention may be continuously operated by utilizing one or more traveling bridge subsystems 140. Such subsystems can move from one filter cell to another filter cell, to effect backwash operations or otherwise facilitate removal of entrapped material in the filter media beds of cells 118, typically while permitting other cells to remain in filtering operation.

Examples of traveling bridge apparatus of this type may be seen in U.S. Pat. Nos. 4,540,487, 4,486,307, 4,133,766, 3,984,326, 2,235,227, and 649,409, each of which are incorporated herein by reference in their entireties. Traveling bridge filter apparatus in accordance with the invention typically comprise one or more carriages, typically movable along tracks, guideways or the like, and having a backwash hood assembly (not shown) that can be engageable with one or more filter cells of the filter apparatus. For downflow type filter apparatus, water or other treatment liquid can be introduced into the cell from below, in a counterflow arrangement to the normal filtering direction. The backwash hood typically includes a suction head (not shown) for drawing backwash fluid and debris forced from the media to the surface as a result of the backwashing operation. As the backwash of an individual cell is completed, the traveling bridge can index the backwash subsystem to the next cell for backwashing operation of that cell. For example, U.S. Pat. No. 4,308,141, which is incorporated herein by reference in its entirety, discloses a modular filter apparatus wherein a traveling bridge type backwash system is indexed to successive filter units.

The tank can further comprise one or more tracks, or guideways, supporting one or more traveling bridge assemblies that can move along the tank in a direction, for example, transverse, relative to the orientation of the cell partitions. In an exemplary embodiment of the invention, the traveling bridge can comprise a carriage from which is suspended surface wash subsystem (not shown) as well as backwash subsystem (not shown), located within a hood subassembly to facilitate cleaning operations or backwashing operations. The wash/backwash hood assembly can extend across, typically substantially, the full width of the tank, i.e., along substantially across, the entire length, of the filter cell.

Typically located within the hood, and typically extending parallel to, and, in some cases, midway between, the lateral lower side wall portions of the hood, is a surface wash manifold subsystem (not shown) that can extend across the width of the tank. At spaced positions, a plurality of discharge nozzles (not shown) can be disposed from which liquid can be dispensed onto the upper surface of the filter bed. The surface wash manifold subsystem can be connected to, for example, a vertically oriented surface wash conduit which can extend upwardly through the hood to a first fluid surface wash pump (not shown) mounted on the traveling bridge carriage. Water can be supplied to the pump from a clean water trough (not shown) adjacent the tank.

A backwash manifold can also be located within the hood, typically above the surface wash manifold, and generally coextensive therewith. In some cases, the backwash manifold can be located in the area of the inclined upper wall portions of the hood. The backwash manifold is typically connected midway along its length to a vertical suction conduit which can also extend through the hood, to a second fluid backwash pump mounted on the traveling bridge carriage. This second pump can serve as a suction pump, the inlet side of which is typically connected to the vertical suction conduit.

The horizontal backwash manifold can have a plurality of uniformly arranged apertures extending along its length and about its periphery to draw liquid and accompanying debris upwardly, for example, out of the filter cell in a direction preferably opposite the normal filter flow direction to effect backwashing of the filter media.

The function and advantages of these and other embodiments of the invention can be further understood from the examples below, which illustrate the benefits and/or advantages of the invention but do not exemplify the full scope of the invention.

### EXAMPLE 1

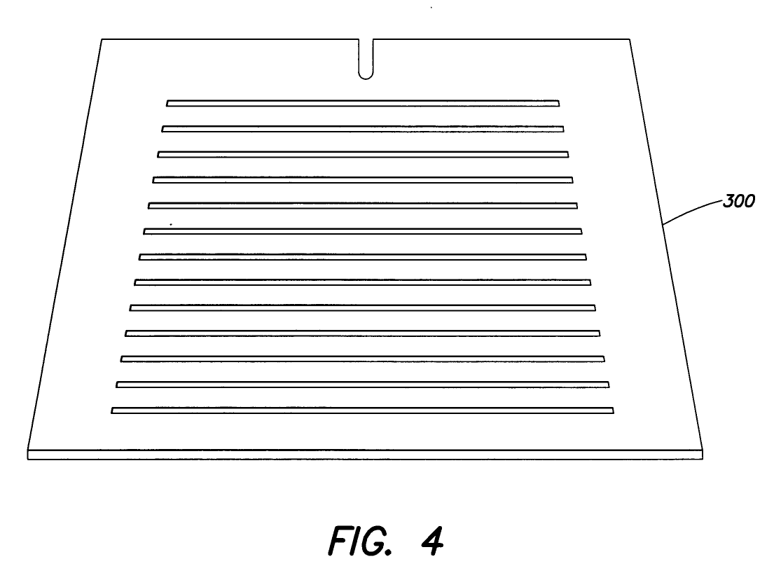

FIG. 3 is a schematic illustration of a support plate in accordance with one or more embodiments of the invention. FIG. 4 is a copy of a photograph of a support plate fabricated in accordance with the invention, schematically illustrated in FIG. 3.

The plate was fabricated by laser cutting about a 3/16 inch thick, 304 stainless steel plate, having a 2B grade finish, to have about 0.015 inch channels spaced about 0.75 inch apart. The 8.75 inch wide plate was further processed by cutting the outer perimeter as well as any holes required for mounting. The laser-cut channels had straight profiles, at about a 90-degree relative to the surfaces, and were visibly free of asperities.

The laser cutting system utilized was a model 4030 laser system from TRUMPF Laser GmbH+Co. KG, Schramberg, Germany, which generated about 3000 watts.

### EXAMPLE 2

The length of the plate fabricated in accordance with Example 1 was cut to accommodate installation in a traveling bridge filter apparatus. The dimensions of the filter apparatus was about 34 feet 11 inches long by about 8 feet wide by about 7 feet deep. The gravity-driven traveling bridge filter apparatus included 18 cells, each about 18 inches wide, had an effective capacity of about 8,377 gallons, and was operated to have an average flow rate of about 800,000 gallons per day with a peak flow of about 1,200,000 gallons per day. Course sand, about 1.2 mm average diameter, about 3 inches deep; fine sand, about 0.55 mm average diameter, about 9 inches deep; and anthracite, about 0.9 mm average diameter, about 6 inches deep, were used as the filter media in each of the cells.

The typical operating water temperature was about 45° F., in the winter, and about 80° F., in the summer. The filter apparatus reduced the suspended solids in the water from about 25 to about 10. In service in the traveling bridge filter apparatus, the laser-cut support plate was expected to have a pressure drop thereacross of less than about 2 psi during normal operation and a pressure drop of less than about 10 psi during backwashing operation.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. For example, the invention may utilize any geometrical channel configurations, or combinations thereof, to provide the desired flow characteristics. Further, acts, elements, and features discussed in connection with one embodiment are not intended to be excluded from a similar role in other embodiments of the invention. It is to be appreciated that various alterations, modifications, and improvements can readily occur to those skilled in the art and that such alterations, modifications, and improvements are intended to be part of the disclosure and within the spirit and scope of the invention. For example, the invention contemplates the use of support member configurations by retrofitting existing treatment facilities with one or more embodiments of the support plate of the invention. Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. The invention is also not limited to traveling bridge filter apparatus. Thus, other applications may avail of the one or more advantages of the invention such as those systems that seek to avoid bacterial growth while providing material retention capabilities.

Use of ordinal terms such as “first,” “second,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed is:

1. A filter media support plate having a filter media-facing surface and a drain-facing surface, the support plate comprising at least one passage having a substantially smooth passage wall, the at least one passage sized to retain filter media while permitting flow of a fluid from the filter media-facing surface to the drain-facing surface.

2. The support member of claim 1, wherein the at least one passage has a smallest dimension of about 0.4 mm.

3. The support member of claim 1, wherein a plurality of passages are spaced at an interval of about 19 mm.

4. The support member of claim 1, wherein the flow of fluid from the filter media-facing surface and the drain-facing surface in the at least one passage is in a tortuous-free fluid path.

5. A traveling bridge filter apparatus including filter media comprising:
an inlet and a drain; and
a support plate disposed to support the filter media, the support plate comprising a media-facing surface and a drain-facing surface and at least one channel defining a flow path from the media-facing surface to the drain-facing surface,
wherein the at least one channel is sized to provide a fluid flow path with an effective pressure drop of less than about 10 psi between the media-facing surface and the drain-facing surface.

6. The apparatus of claim 5, wherein the at least one channel has a smallest dimension that is less than an average smallest dimension of the filter media.

7. The apparatus of claim 5, wherein the fluid flow path is substantially tortuous-free.

8. The apparatus of claim 5, wherein the at least one channel has a channel wall that is substantially free of asperities.

9. The apparatus of claim 5, wherein the at least one channel has a smallest dimension less than an average diameter of the filter media.

10. The apparatus of claim 5, wherein the at least one channel is sized to retain filter media in the filter apparatus.

11. A method of fabricating a media support member comprising an act of laser cutting at least one channel through a plate, the at least one channel sized to prevent entry of filter media while permitting a fluid to pass through the at least one channel.

12. The method of claim 11, wherein the at least one channel has a smallest dimension less than about an average diameter of the filter media.

13. The method of claim 12, wherein the at least one channel has a wall that is substantially free of asperities.

14. The method of claim 13, wherein the at least one channel defines a fluid flow path that is tortuous-free.

15. A method of treating water in a filter apparatus having at least one filter cell defined at least by filter cell walls and a filter cell media support plate, the filter media support plate having a media-facing surface and a drain-facing surface comprising acts of:
introducing water into the at least one filter cell;
promoting water passage through the filter media; and
draining water through the filter cell media support plate in a tortuous-free flow path from the media-facing surface to the drain-facing surface.

16. The method of claim 15, wherein the tortuous-free flow path is defined by at least one channel in the filter media support plate, the at least one channel having a smallest dimension less than about an average diameter of the filter media.

17. The method of claim 16, wherein the at least one channel has channel walls substantially free of asperities.

18. The method of claim 15, wherein the act of draining water is performed with a pressure drop across the filter media support plate of less than about 70 kilopascals.
